(19) United States
(12) Patent Application Publication
(10) Pub. No.: US 2003/0234958 A1
(43) Pub. Date: Dec. 25, 2003

(54) Printing system

(76) Inventors: Terry-Lee M. Fritz, Boise, ID (US); Dana A. Jacobsen, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/179,694

(22) Filed: Jun. 24, 2002

(51) Int. Cl. G06F 3/13; G06F 15/00; G06F 13/00

(52) U.S. Cl. 358/1.16; 358/1.15

(57) ABSTRACT

A printing system is described. The printing system may include a printer connected to a storage system over a network system. The printer includes a non-volatile memory and can locally retain jobs in the memory. The printer can also select a locally retained job for archival and can then archive the selected job on the storage system.

### BACKGROUND

Today, some printers are able to locally retain print jobs indefinitely in a local non-volatile memory for future printing. For ease of discussion, printers that have this capability may be referred to, herein, as supporting “retention printing”. For ease of discussion, a printer that supports retention printing may be referred to herein as a “retention printer”. One example of a retention printer is described in the patent entitled “MULTIPLE COPY PRINTER WITH PRINT JOB RETENTION”, having U.S. Pat. No. 6,160,629. That patent is incorporated herein by reference

There are a number of different types of retention printing. One type of retention printing is commonly referred to as “quick-copy printing”. According to quick-copy printing, a printer retains a received job in a local non-volatile memory. In addition, the printer prints the job. Thereafter, a user can print additional copies of the retained job. Typically, the user can accomplish this task by inputting an appropriate request at the local control panel of the printer. The printer responds to the request by accessing the job from the memory and then printing the requested copies.

A second type of retention printing is commonly referred to as “Proof and Hold printing”. According to “Proof and Hold printing”, a printer retains a received multi-copy print job in memory and prints a limited number of copies (typically one copy). Thereafter, a user can cause the rest of the copies to be printed by, for example, inputting an appropriate request at the printer control panel.

A third type of retention printing is commonly referred to as “private printing”. According to private printing, a printer retains a received print job and delays printing the job until the printer receives a privacy code. Upon receiving the appropriate code, the printer prints the job.

A fourth type of retention printing is commonly referred to as “simple retention printing”. According to simple retention printing, a printer retains a received print job and does not immediately print it. Future printing of the retained job is available to users by, for example, the user inputting an appropriate request at the printer control panel.

For purposes of this application, a print job that invokes any type of retention printing described above may generally be referred to herein as a “retention job”. Additionally, a print job that directs a printer to perform “quick-copy printing” may be referred to herein as a “quick-copy job”. A print job that directs a printer to perform “poof and hold printing” may be referred to herein as a “proof and hold job”. A print job that directs a printer to perform “private printing” may be referred to herein as a “private printing job”. A print job that directs the printer to perform “simple retention printing” may be referred to herein as a “simple retention job”.

One problem with retention printing is associated with the limited storage space that is available at the printer to retain jobs. As the printer retains more and more jobs, the storage space is depleted. At some point, the retention printer may be unable to retain additional jobs.

### SUMMARY

In accordance with one embodiment a method comprises receiving, sequentially, a plurality of retention jobs; processing each one of the jobs, at least in part, by retaining each one of the jobs in a local non-volatile memory; selecting one of the retained jobs for archival; and archiving the selected job on a remote storage system.

### DESCRIPTIONS OF THE DRAWINGS

FIG. 1 shows a computing system in accordance with a first embodiment of the invention;

FIG. 2A and FIG. 2B illustrate an aspect of a printer;

FIG. 3 shows a computing system in accordance with a second embodiment of the invention;

FIG. 4 is a high-level block diagram of a printer;

FIG. 5 illustrates the operation of the printer upon receiving a “quick-copy” job;

FIG. 6A and FIG. 6B illustrates an aspect of the printer functionality;

FIG. 7 illustrate the operation the printer to receive and respond to a request to re-print the “target job” after the job has been archived;

FIG. 8A illustrates an example of a job archive system; and

FIG. 8B illustrates another example of a job archive system.

### DESCRIPTION

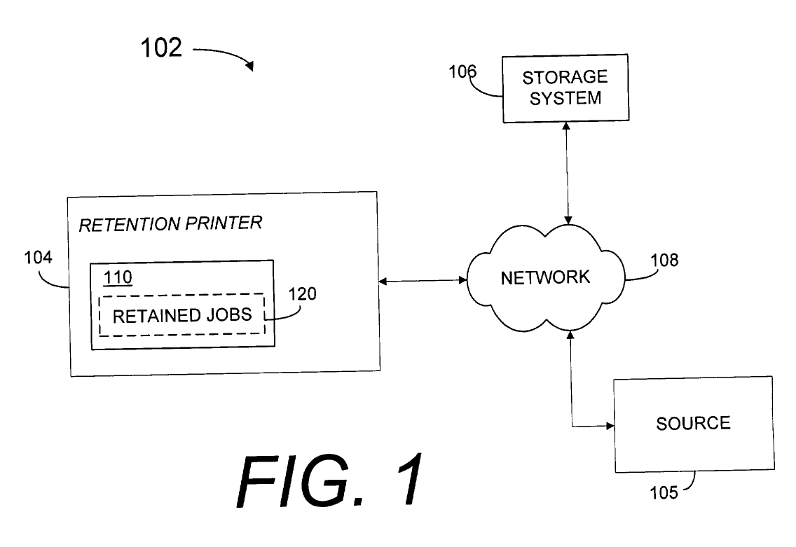

FIG. 1 shows a computing system 102 that incorporates an embodiment of the invention. The computing system 102 includes a printer 104, a source 105 and a storage system 106. All these devices are connected to a network 108.

The printer 104 supports at least one of the retention printing types described. As shown, the printer 104 includes a local memory 110. The memory 110 is a non-volatile memory and is used by the printer 104 to retain jobs. The source 105 may represent any device or device(s) that is capable of transmitting retention jobs to the printer 104 over the network 108.

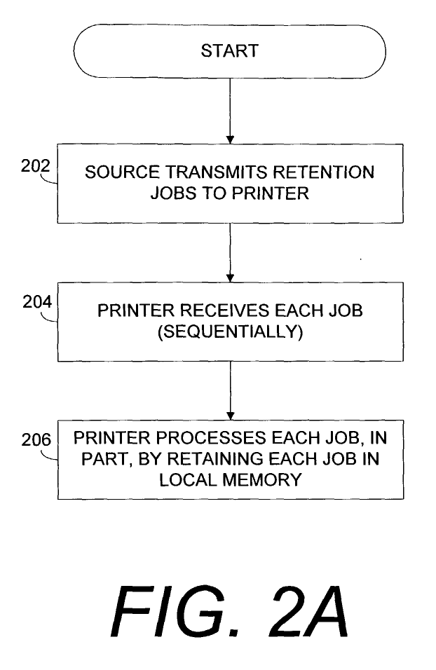

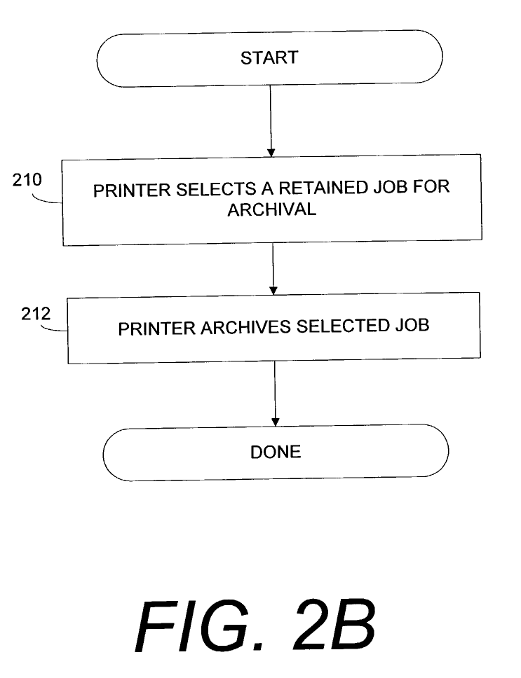

FIG. 2A and FIG. 2B illustrate an aspect of the printer 104 operation. Turning to FIG. 2A, it is assumed the source 105 functions to transmit, sequentially, retention jobs to the printer 104 (step 202). The printer 104 receives each of these jobs in the order they are transmitted (step 204).

As each retention job is received, the printer 104 processes the job appropriately (step 206). This includes retaining the job in the local memory 110. Step 206 may also include printing the job. “Quick-copy jobs”, for example, are processed by both retaining the job in the memory 110 and printing the job.

In the next part of this discussion, it is assumed that the printer 104 is presently retaining a set of jobs 120 in the memory 110. Turning now to FIG. 2B, the printer 104 automatically selects at least one of the retained jobs from the set of jobs 120 to archive (step 210). Next, the printer 104 operates to archive the selected job on the remote storage system 106 (step 212). Step 212 may involve the printer 104 transmitting the selected job over the network 108 to the storage system 106. The storage system 106 receives the selected job and functions to archive the selected job.

SECOND EMBODIMENT

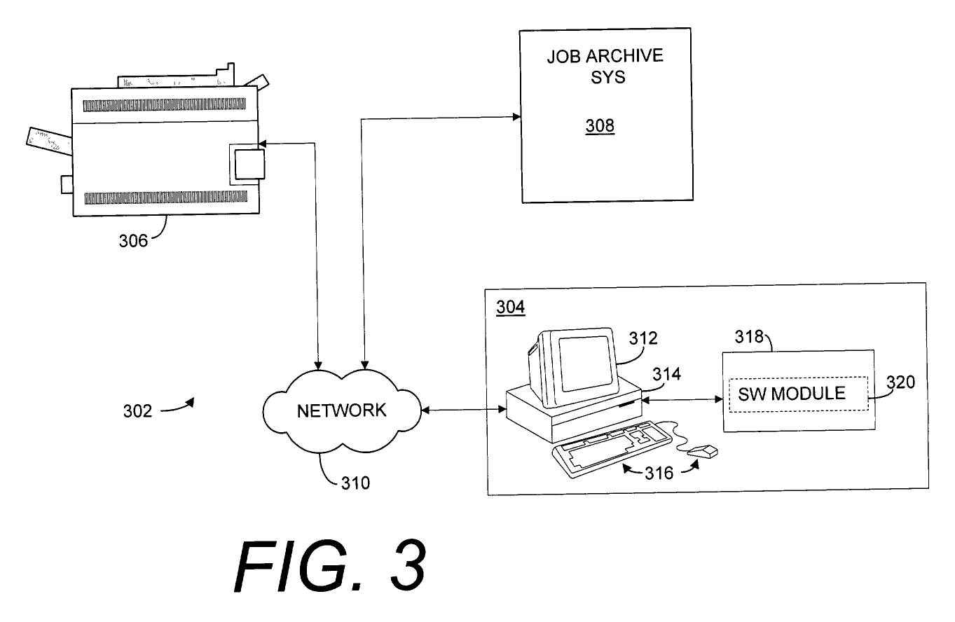

FIG. 3 shows a second embodiment of the invention in the form of a computing system 302. As shown, the computing system 302 includes a user computer 304, a printer 306 and a job archive system 308. All these devices are connected to a network 310.

The user computer 304 may represent, for example, a personal computer, a workstation, a network computer, etc. The user computer 304 includes a display device 312, a processor unit 314, user input devices 316 and a memory 318. The memory 318 is shown being external to the processor unit 314 but may in fact be physically located within the processor unit 314. Stored in the memory 318 is a software module 320. The processor unit 314 can execute the software module 320.

The software module 320 enables the computer 304, at the direction of a user, to generate and transmit a retention job to the printer 306. The software module 320 may include, for example, a word processing application and a print driver.

PRINTER BLOCK DIAGRAM

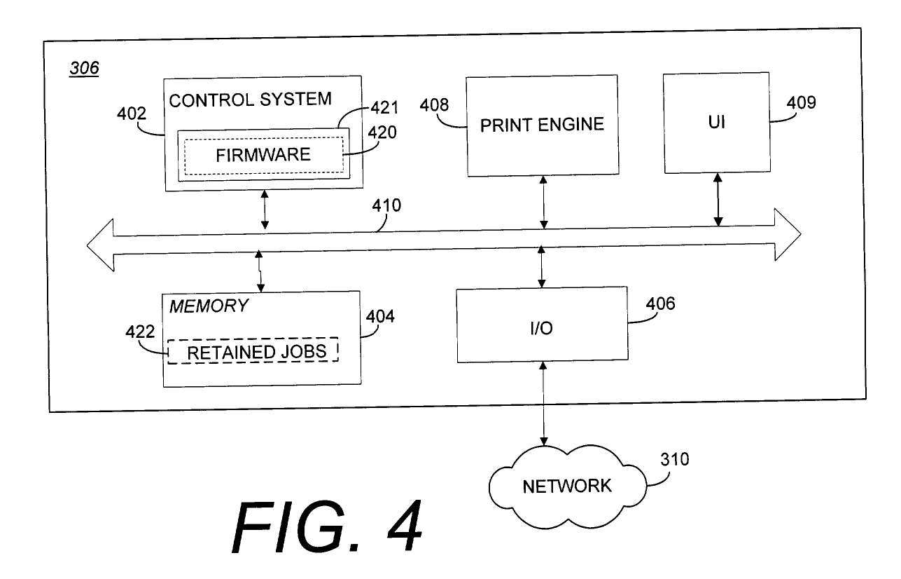

FIG. 4 shows a high-level block diagram of the printer 306 according to one specific implementation. As shown in FIG. 4, the printer 306 includes a control system 402, a memory 404, an input-output (I/O) port 406, a print engine 408 and a user interface 409. All these items are connected via a local interface 410. It is noted that the printer 306 may also include other components that are not shown. For example, the printer 306 may include a scanner for enabling walk-up users to make copies.

The printer's local interface 410 may include, for example, one or more data buses with accompanying control buses. Furthermore, the user interface 409 may represent one or more local control panels that are accessible to walk-up users.

The I/O port 406 facilitates communications with other devices over the network 310. For example, the I/O port 406 enables the printer 306 to receive a retention job over the network 310 from the user computer 304. The I/O port 406 also enables the printer 306 to transmit retention jobs over the network system 310 to the job archive system 308 for archival purposes.

The print engine 408 includes the necessary hardware for enabling the printer 306 to controllably place marks on media. The print engine 408 may incorporate any type of printing technology. For example, the print engine 408 may be a laser print engine, an ink jet print engine, a dye sublimation print engine, a thermal dye print engine, etc.

The memory 404 is a non-volatile memory and is used by the printer 306 to retain jobs. The memory 404 may represent, for example, one or more disk drives or any other type (or types) of non-volatile storage device. In other embodiments, the memory 404 may represent a volatile memory, such as a Random Access Memory (RAM).

The control system 402 orchestrates the operation of the printer 306. The control system 402 may include one or more microprocessors, various memory devices and other hardware circuits. Aspects of the control system 402 operation is directed by the execution of firmware 420 which is stored in a memory 421.

OPERATION OF PRINTER (RETENTION PRINTING)

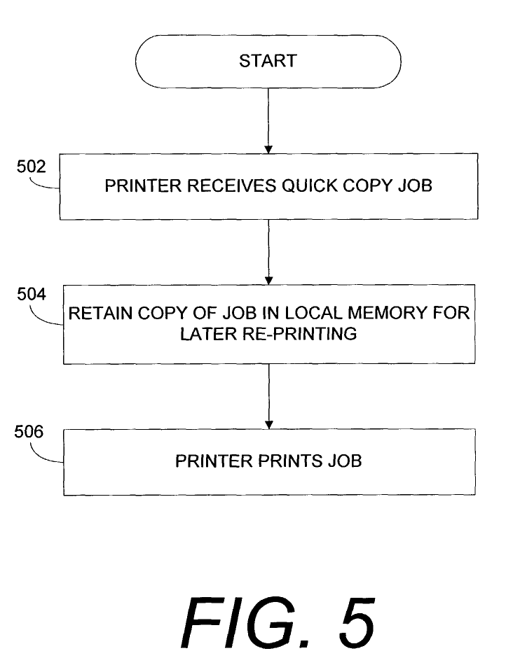

It is noted that the printer 306 supports retention printing. FIG. 5 illustrates, for example, the operation of the printer 306 upon receiving a “quick-copy” job from, for example, the computer 304.

Turning now to FIG. 5, the printer 306 receives a “quick-copy job” from the computer 304 over the network 310 (step 502). The “quick-copy job” includes the appropriate commands for directing the printer 306 to perform “quick-copy” printing.

In response to the quick-copy job, the printer 306 operates to retain the job in the memory 404 (step 504). Additionally, the printer 306 operates to print the job (step 506).

Thereafter, a walk-up user can cause additional copies of the retained job to be printed by inputting an appropriate request at the printer's local user interface 409.

OPERATION OF PRINTER (JOB ARCHIVAL)

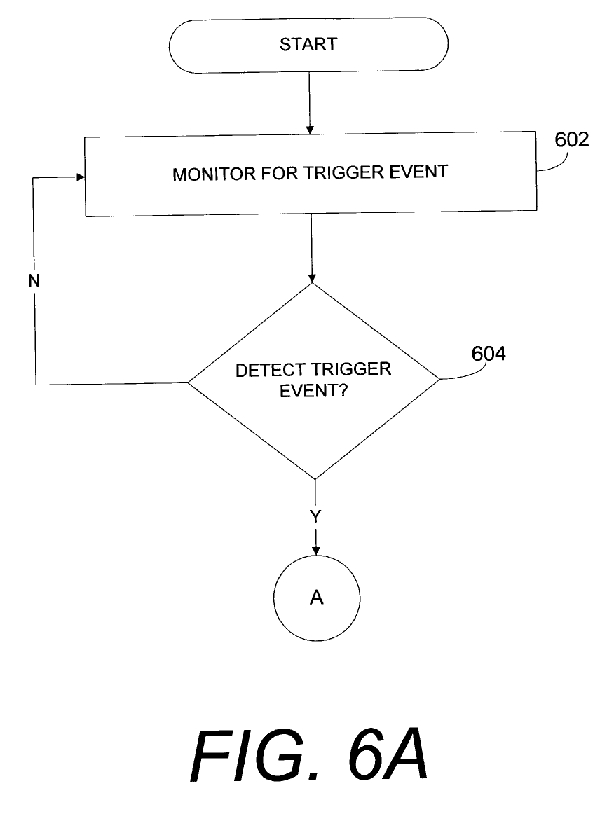

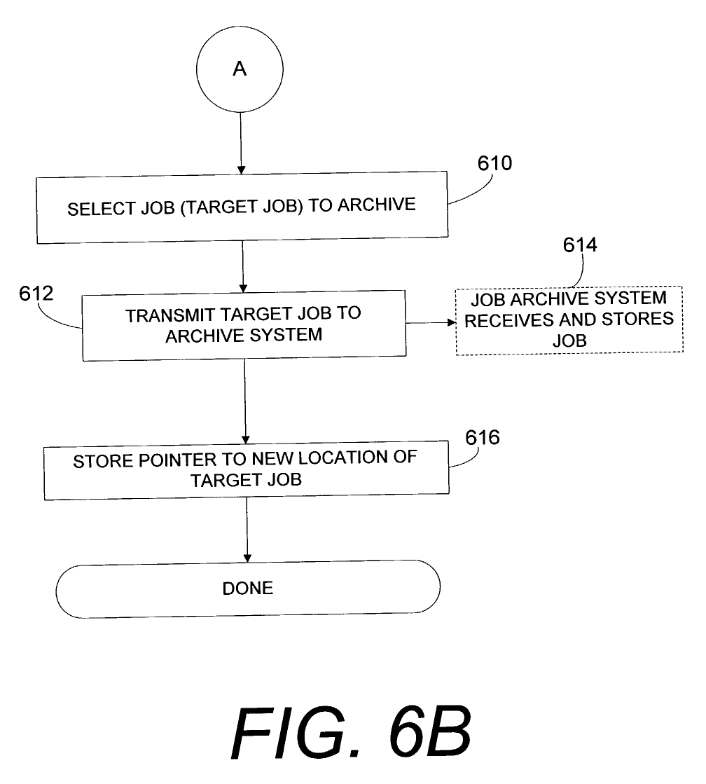

In this embodiment, the printer 306 can also function to archive locally retained jobs on the job archive system 308. FIG. 6A and FIG. 6B illustrates this aspect of the printer 306 functionality. As the steps in FIG. 6A are described, the printer 306 is assumed to be presently retaining a group of jobs 422 in the memory 404 (see FIG. 4).

Turning to FIG. 6A, the printer 306 monitors for a predetermined “trigger event” (step 602). Upon detecting this event, the printer 306 operates to select a job from the group of retained jobs 422 (step 610). [For ease of the following discussion, the job selected at step 610 may be referred to herein as the “target job”. It is also noted that the target job is selected in accordance with a predefined “job selection policy”. Examples of possible “trigger events” as well as possible “job selection policies” are provided below.]

The printer 306, at step 612, operates to transmit the target job to the job archive system 308. The job archive system 308 receives and archives the target job (step 614).

Additionally, the printer 306 stores information that can later be used to retrieve the target job. In this example embodiment, the printer 306 stores a pointer to the new location of the target job (step 616). The printer 306 can later make use of the pointer to retrieve a copy of the target job from the job archive system 308.

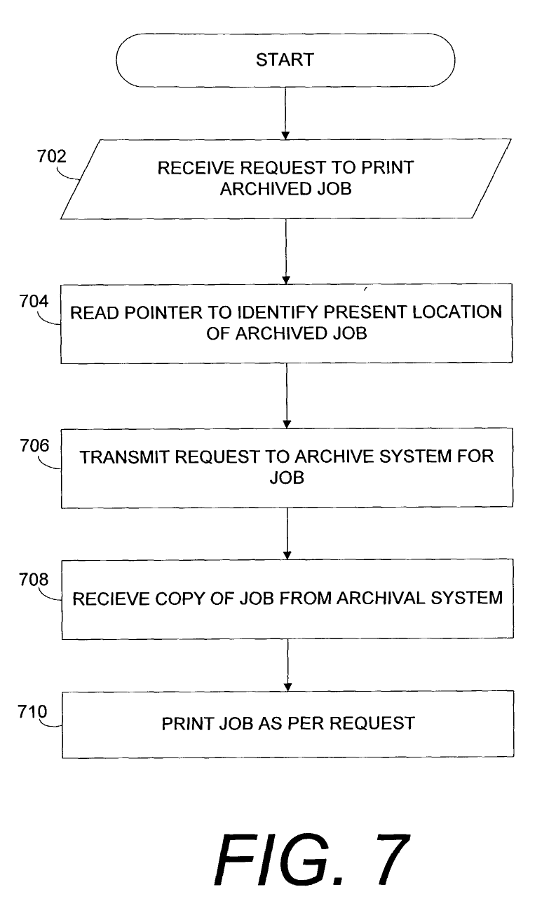

In the present embodiment, after a job is archived by the printer 306, a walk-up user of the printer 306 can still re-print the job. FIG. 7 illustrates, for example, the operation the printer 306 to receive and respond to a request to re-print the above mentioned “target job” after the job has been archived.

Referring now to FIG. 7, a walk-up user to the printer 306 interacts with the user interface 409 to input an appropriate request to print a copy of the archived target job (step 702).

In response to the request, the printer 306 reads the pointer that was stored at step 616 in order to locate the target job on the archive system 308 (step 704). The printer 306 makes use of this information to transmit an appropriate request, over the network 310, to the archive system 308 (step 706).

In response to the request, the archive system 308 returns a copy of the target job to the printer 306. The printer 306 receives the copy and prints it (step 708 and step 710).

TRIGGER EVENT EXAMPLES

As indicated above, the printer 306 monitors for a “trigger event” at step 602. Upon detecting a trigger event, the printer 306 proceeds to archive a retained job. In the next part of this description, some specific examples of “trigger events” that could be used to trigger the archival of a retained job are discussed.

Trigger Event Example #1

According to one implementation, the printer 306 is configured to archive a job when the capacity of the memory 404 to retain new jobs falls below a pre-determined threshold value. Thus, for example, at step 602 the printer 306 may monitor the memory 404 to determine when the capacity of the memory 404 to retain additional jobs falls below a threshold value. Once this event is detected (step 604), the printer 306 proceeds to archive one (or more) of the retained jobs 422.

Trigger Event Example #2

According to another implementation, the printer 306 is configured to archive those jobs that have been retained for a threshold period of time.

Thus, at step 602, the printer 306 may monitor the retained jobs 422 to identify jobs that have been retained for more than, for example, one week (other time periods, of course, may be used). Once a job that meets this criterion is detected, the printer 306 proceeds to archive the job.

Trigger Event Example #3

According to yet another implementation, the printer 306 is configured to archive those retained jobs that have not been accessed from the memory 404 for at least a threshold period of time.

Thus, at step 602, the printer 306 may monitor the retained jobs 422 to identify jobs that have not been accessed for printing for more than 48 hours. Once a job that meets this criterion is detected, the printer 306 proceeds to archive the job.

Trigger Event Example #4

According to other implementations, retained jobs are each assigned an “expiration date”. The expiration date may be assigned, for example, by operation of the computer that originated the job (e.g., the computer 304) or by operation of the printer 306.

Thus, at step 602, the printer 304 may monitor the retained jobs 422 to identify those jobs that have “expired”. Once a job that meets this criterion is detected, the printer 306 proceeds to archive the job.

JOB SELECTION POLICY EXAMPLES

As noted above, the printer 306 operates to select a job to archive at step 610. The selection of the job is performed in accordance with a pre-defined “job selection policy”. Some example job selections policies have already been discussed above.

For example, the printer 306 may select a retained job based upon the amount of time the job has been retained (see trigger event example #2). The printer 306 may also select a retained job based upon the length of time that has past since the job was last accessed from the memory 404 (see trigger event example #3). The printer 306 may also select a retained job based upon an assigned expiration date (see trigger event example #4).

Additional examples of “job selection policies” are provided below.

Job Selection Policy Example #1

According to one implementation, the printer 306 is configured to select the retained job, from the group of retained jobs 422, that has not been accessed for re-printing for the longest period of time. Thus, for example, assume the retained jobs 422 include only two jobs, Job A and Job B. Job A was last accessed 2 hours ago for printing. Job B was last accessed 24 hours ago for printing. In this example, the printer 306 would select Job “B” at step 610 for archival as job “B” has not been accessed for the longest period of time.

Job Selection Policy Example #2

According to another implementation, the printer 306 is configured to select the retained job, from the group of retained jobs 422, that was received first by the printer 306.

Thus, for example, assume again that retained jobs 422 include only two jobs: Job “A” and Job “B”. Job “A” was received first by the printer 306. In this example, the printer 306 operates to select Job “A” for archival as this job is the “oldest” retained job.

Job Selection Policy Example #3

According to yet another implementation, the printer 306 is configured to select the retained job, from the group of retained jobs 422, that has the greatest file size.

JOB RETRIEVAL

In the embodiment just described the printer 306 stores a pointer when a job is archived. The printer 306 can later use the pointer to retrieve the archived job. It is noted that in other implementations, the printer 306 can identify a previously archived job without the use of a pointer. For example, the printer 306 may be configured to perform a discovery procedure over the network 310 to locate a previously archived job.

ARCHIVE SYSTEM

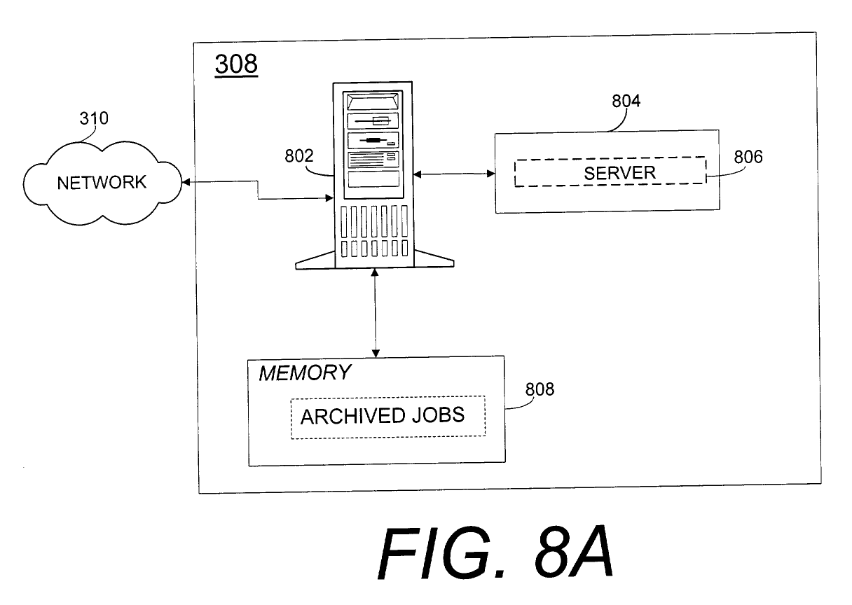

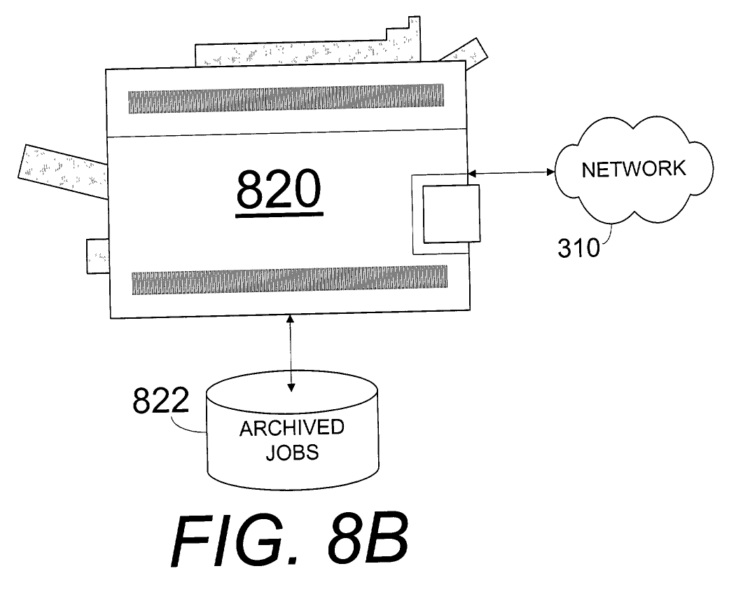

FIG. 8A illustrates the job archive system 308. As shown, the job archive system 308 includes a server computer 802 and an associated memory 804 that is used to store a server program 806. The server computer 802 runs the program 806.

The server program 806 enables the job archive system 308 to archive jobs (e.g., the target job described above) received from the printer 306 over the network 310 and to return copies of these archived jobs upon receiving an appropriate request from the printer 306.

The job archive system 308 includes a memory 808 that is used to archive jobs. The memory 808 may represent, for example, one or more disk drives, one or more tape drives, one or more optical based storage systems or some combination thereof.

It is noted that in other embodiments, the job archive system may be configured differently. For example, FIG. 8B shows one alternative implementation of the archive system 308. In this case, the job archive system is a retention printer 820. The retention printer 820 can receive jobs from other retention printers and can archive these jobs in a local non-volatile memory 822. The memory 822 may represent, for example, a local disk drive.

It is noted that in still other embodiments, the job archive system operates to archive jobs in a hierarchical fashion. For example, the job storage system may include a disk drive and a tape drive. Jobs, when first received, are archived on the disk drive. After a period of time, the job may then be moved to the tape drive for long term storage.

In still other embodiments, the job archive system may be an Internet Service Provider (ISP) that archives jobs received over the INTERNET. The ISP may charge a fee for use of this service.

OTHER EMBODIMENTS

It is also noted that the present invention may be embodied in the form of a “computer-readable medium ” that stores (either temporarily or permanently) computer executable instructions for performing the steps depicted in one or more of the flow diagrams described above. As used herein, the phrase “computer-readable medium” can refer to any medium that can contain, store or propagate computer executable instructions. Thus, in this document, the phrase “computer-readable medium” may refer to a medium such as a CD ROM or a magnetic storage device. The phrase “computer-readable medium” may also refer to signals that are used to propagate the computer executable instructions over a network or a network system, such as the Public Internet.

Although several specific embodiments of the invention have been described and illustrated, the invention is not to be limited to specific forms or arrangements of parts so described and illustrated. The invention is limited only by the claims and the equivalents thereof.

What is claimed is:

1. In a retention printer, a method comprising:
(a) receiving, sequentially, a plurality of retention jobs;
(b) processing each one,,of the jobs, at least in part, by retaining each one of the jobs in a local non-volatile memory;
(c) selecting one of the retained jobs for archival; and
(d) archiving the selected job on a remote storage system.

2. The method of claim 1, wherein the plurality of retention jobs includes at least one quick-copy job and step (b) includes printing the at least one quick-copy job.

3. The method of claim 1, wherein step (c) is performed in accordance with a pre-determined job selection policy.

4. The method of claim 1, further comprising:
(e) after step (d) is performed, receiving a user request to print the selected job; and
(f) responding to the request by retrieving the selected job from the remote storage system and printing the retrieved selected job.

5. The method of claim 1, further comprising:
(e) determining that the capacity of the memory to retain new jobs is below a pre-determined threshold; and wherein step (c) is performed in response to step (e).

6. The method of claim 1, wherein step (c) is performed by selecting a retained job that has not been accessed from the memory for at least a threshold period of time.

7. The method of claim 1, wherein step (c) is performed by selecting the first job received at step (a).

8. The method of claim 1, wherein the remote storage system is another retention printer.

9. A printing device, comprising:
(a) a local non-volatile memory;
(b) means for retaining jobs in the local memory;
(c) means for selectively archiving jobs retained in the local memory on a remote storage system;
(d) means for receiving a request to print a first job archived on the remote system;
(e) means for responding to the request by retrieving the first job from the remote storage system and then printing the first job.

10. The printing device of claim 9, wherein the local memory includes at least one disk drive.

11. The printing device of claim 9, wherein the responding means includes a print engine.

12. A printer, comprising:
(a) an I/O port capable of receiving, sequentially, a plurality of retention jobs;
(b) a non-volatile memory; and
(c) control apparatus enabled to process each retention job received at the I/O port, in part, by retaining each job in the memory; and wherein the control apparatus is further enabled to automatically select a job retained in the memory for archival and to then archive the selected job on a remote storage system.

13. The printer of claim 12, further comprising:
(d) a print engine; and wherein the control apparatus is enabled to process a quick-copy retention job received at the I/O port by printing the quick-copy job and retaining the quick-copy job in the memory.

14. The printer of claim 12, wherein the control apparatus operates to select a job retained in the memory for archival only when the capacity of the memory to retain new jobs falls below a threshold value.

15. A computing system, comprising:
(a) a printer enabled to receive a retention job from an external computer and to process the retention job, in part, by retaining the job in a local non-volatile storage device;
(b) a storage system, coupled to the printer over a network system, for archiving print jobs; and
wherein the printer is enabled to automatically archive the job on the storage system when pre-determined conditions exist.

16. The computing system of claim 15, wherein the print job is assigned an expiration date and the printer archives the job when the expiration date has passed.

17. The computing system of claim 15, wherein the print job is assigned an expiration date and the printer archives the job when the expiration date has passed and the available space on the storage device is below a pre-determined threshold.

18. The computing system of claim 15, wherein the printer archives the print job when the available space on the storage medium is below a pre-determined threshold and the job has a file size that is greater than all other jobs presently retained by the printer.

19. A method of archiving a job, comprising:
(a) generating, by a computer, a quick-copy print job;
(b) transmitting, by the computer, the job to a printer;
(c) receiving, by the printer, the job;
(d) responding, by the printer, to the job by retaining a copy of the job in a memory local to the printer and by printing a copy of the job; and
(e) detecting, by the printer, a trigger event; and
(f) in response to detecting the trigger event, archiving the retained copy of the job on a system remote to the printer.

20. The method of claim 19, further comprising:
(g) after step (f) is performed, receiving, by the printer, a request to print the job;
(h) responding to the request; and wherein step (h) includes retrieving the job from the remote system and printing the retrieved job.
